(19) United States
(12) Patent Application Publication
(10) Pub. No.: US 2004/0040231 A1
(43) Pub. Date: Mar. 4, 2004

(54) Mounting frame for a recessed light

(76) Inventor: Heng-Lun Tseng, Taipei (TW)

Correspondence Address: Alan D. Kamrath, Rider, Bennett, Egan & Arundel, LLP, 333 South Seventh Street, Suite 2000, Minneapolis, MN, 55402, US

(21) Appl. No.: 10/233,706

(22) Filed: Sep. 3, 2002

(51) Int. Cl. E06B 1/04

(52) U.S. Cl. 52/204.1; 52/474

(57) ABSTRACT

A mounting frame for a recessed light includes a first section with a first head and a first body pivotally connected to the first head and a second section with a second body and a second head securely and firmly connected to the second body. The first head has a positioning device formed on a side face of the first head to allow the first section to be initially positioned on a surface. A first deformation and a second deformation are formed on the first body. A guiding path is longitudinally defined in the first body. The second body has a third deformation and a fourth deformation formed on the second body and a third guiding path longitudinally defined in the third deformation. The second body further has a fourth path longitudinally defined in the fourth deformation.

### BACKGROUND OF THE INVENTION

1. Field of the Invention

The present invention relates to a mounting frame, and more particularly to a mounting frame for a recessed light, which enables the user to readily position the location where the recessed light is to be mounted.

2. Description of Related Art

A conventional mounting frame, as shown in FIGS. 8 and 9, for a recessed light is composed of a first section (50) and a second section (not shown) detachably connected to the first section (50). The first section (50) is provided with a first body (51) and a first head (52) pivotally connected to the first body (51) by means of riveting and having a first ledge (53) integrally formed on a distal end of the first head (52). The first body (51) has a second ledge (511) integrally formed with the first body (51) and being orthogonal relative to the first ledge (53). The second section is provided with a second body and a mounting head firmly connected to the second body and having a second hook integrally formed with the mounting head.

With the conventional mounting frame, the user is able to hold the first section (50) to a location where the recessed light is to be mounted and then fix the first section (50) to the location by using nail extending through the first head (52). Thereafter, the user connects the second section to the first section (50) and pivots the first body (51) to a location horizontal to the first head (52) by using the first ledge (53) as a stop. Finally the user mount the second section by using another nail onto a ceiling support that is made of wood.

Although the user is able to use the pivotal feature of the first head (52) to readily position the first section (50) to the ceiling support, the conventional mounting frame still suffers from several drawbacks.

The structural integrity of the mounting frame is weak.

Often during the assembly of the recessed light, the mounting frame is deformed due to the labor work or the weight of the recessed light.

Location of the first section of the mounting frame is not precisely correct.

Because there is no positioning device provided to the first section of the mounting frame, the user will experience difficulty trying to position the first section to a precise location.

To overcome the shortcomings, the present invention tends to provide an improved mounting frame for a recessed light to mitigate and obviate the aforementioned problems.

### SUMMARY OF THE INVENTION

The primary objective of the present invention is to provide an improved mounting frame for a recessed light. The mounting frame is composed of a first section and a second section. The first section has a positioning device formed on a side face of the first head of the first section so that the user is able to use the positioning device to position the first section to a location where the recessed light is to be mounted.

Another objective of the present invention is that the first section and the section are respectively provided with a deformation on the respective body to reinforce the structural integrity.

In order to accomplish the foregoing objective, the mounting frame of the present invention includes a first section and a second section detachably connected to the first section. The first section is provided with a first body and a first head pivotally connected to the first body by means of riveting and having a first ledge integrally formed on a distal end of the first head and a second ledge integrally formed with the first body and being orthogonal relative to the first ledge. The second section is provided with a second body and a mounting head firmly connected to the second body and having a second hook integrally formed with the mounting head. A positioning device is provided on a side face of the first head so that the user is able to use the positioning device to readily position the first section to a location where the recessed light is to be mounted. Both the first body and the second body of the mounting frame have a deformation so that the first section and the second section are structurally reinforced.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the mounting frame of the present invention;

FIG. 2 is an enlarged perspective view of the first head of the first section of the mounting frame in FIG. 1;

FIG. 3 is a schematic view showing that the first ledge and second ledge respectively function as a stop to the first body when the first body pivots;

FIG. 4 is a cross sectional view showing a section of the first body by taking line 4-4 in FIG. 3;

FIG. 5 is a cross sectional view showing another section of the first body by taking line 5-5 in FIG. 3;

FIG. 6 is schematic view showing that the first section is slidable with respect to the second section;

FIG. 7 is an embodiment of two mounting frames of the present invention are employed to support a recessed light;

FIG. 8 is an exploded perspective view of the first section of a conventional mounting frame; and

FIG. 9 is a schematic side plan view showing the pivotal movement of the first head of the conventional first section in FIG. 8.

### DETAILED DESCRIPTION OF THE PREFERRED EMBODIMENT

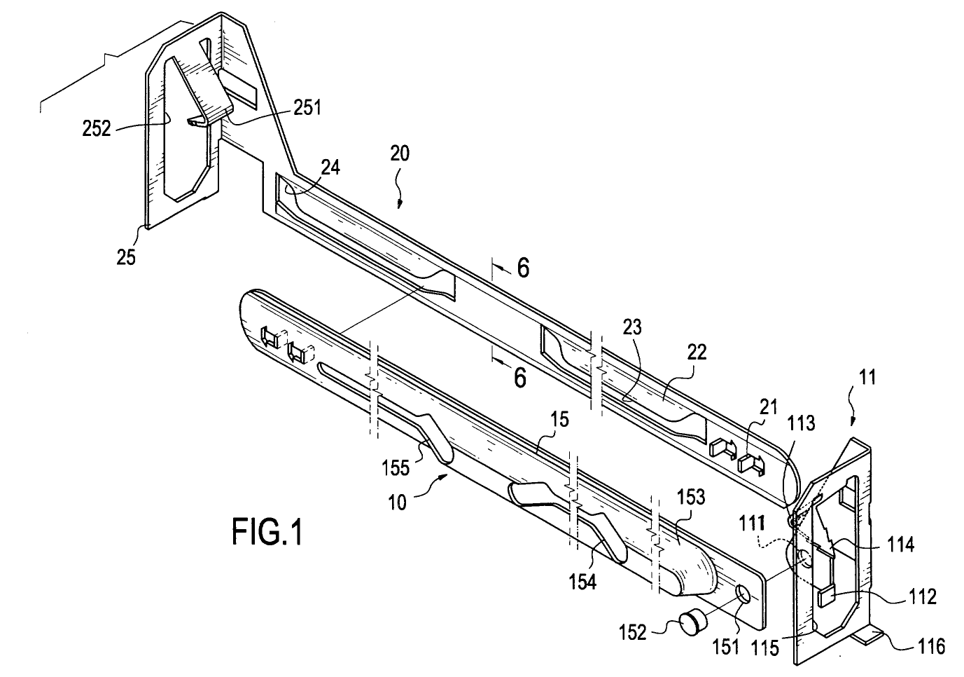

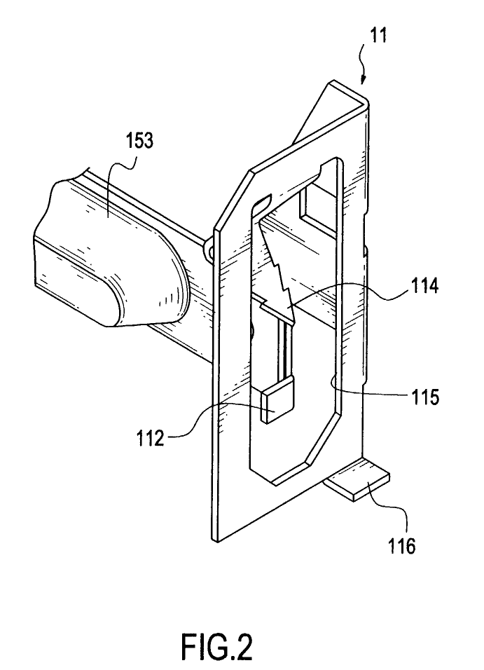

With reference to FIGS. 1 and 2, the mounting frame in accordance with the present invention is composed of a first section (10) and a second section (20) detachably connected to the first section (10).

The first section (10) has a first head (11) and a first body (15). The first head (11) is pivotally connected to a first end of the first body (15) and has a pin hole (111), a first ledge (112), a second ledge (113) orthogonal to the first ledge (112), a first hook (114) integrally formed with the first head (11), a first through hole (115) defined to correspond to the first hook (114). A positioning device is formed on a side face of the first head (11). Preferably, the positioning device is a stop (116) formed on the side face of the first head (11).

The first body (15) has a hole (151) defined to correspond to the pin hole (111) so that a rivet (152) is able to extend through the hole (151) and the pin hole (111) to pivotally connect the first body (15) to the first head (11). The first body (15) further has a deformation (153) longitudinally formed on sections of the first body (15), a first guiding path (154) and a second guiding path (155) respectively defined in the deformation (153). A pair of first fingers (156) are formed on a bottom face of a second end of the first body (15).

The second section (20) has a pair of second fingers (21) formed on a top face of a first end of the second section (20), a second deformation (22) longitudinally formed on the second section (20), a third guiding path (23) and a fourth guiding path (24) respectively defined in the second deformation (22). A second head (25) is firmly connected to the first section (20) and has a second hook (251) integrally formed with the second head (25) and having a second through hole (252) defined to correspond to the second hook (251).

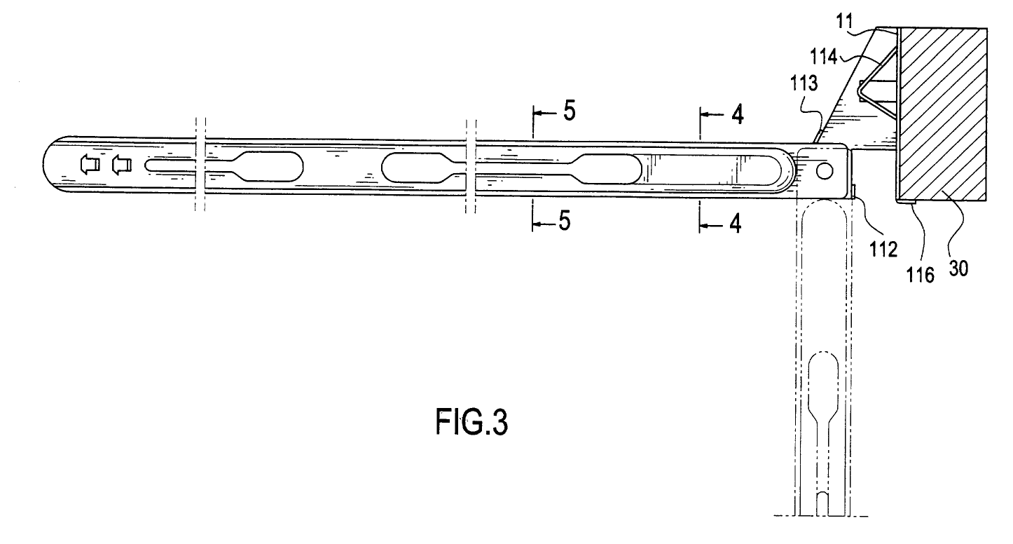

With reference to FIG. 3, when the rivet (152) extends into the hole (151) and the pin hole (111) of the first head (11), the first head (11) is able to pivot relative to the first body (15). When the first head (11) pivots, the first and second ledge (112,113) respectively functions as a stop to the pivotal movement of the first head (11). Because the first ledge (112) and the second ledge (113) are respectively orthogonal with respect to each other, the first head (11) is able to move in a range of 90 degrees relative to the first body (15). Furthermore, when the user is using the first section (10), the user is able to place the stop (116) to abut a bottom face of a ceiling support (30) to fix the location of the first head (11) and then extend the first hook (114) into the ceiling support (30) to securely engage the first head (11) with the ceiling support (30).

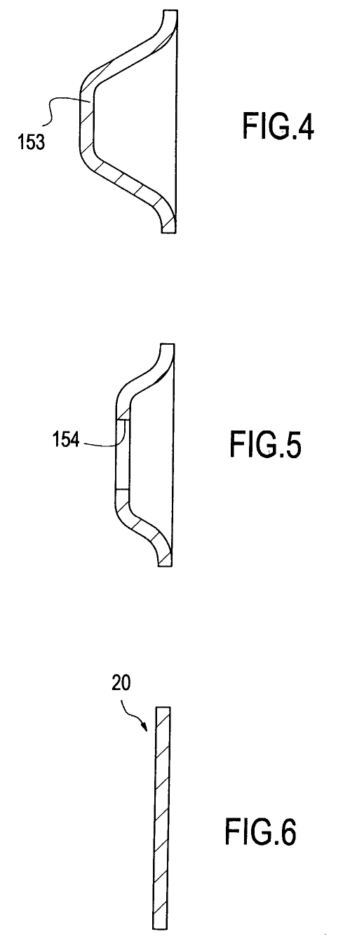

With reference to FIGS. 4, 5 and 6, it is noted that a position where line 4-4 cuts has the largest deformation magnitude, a position where line 5-5 cuts has the medium magnitude and a position wherein line 6-6 cuts has the least magnitude. Actually, the position where line 6-6 cuts shows that the position is a plain face. That is, the first deformation (153) in the first section (10) has at least two different deformations magnitude and the deformation (22) in the second section (20) also has two different magnitudes

With reference to FIG. 6, when the first section (10) is to be connected to the second section (20), the pair of first fingers (156) is inserted into a corresponding one of the third or the fourth guiding paths (23,24) and the pair of second fingers (21) is inserted into a corresponding one of the first or the second guiding paths (154,155). Thereafter, the first section (10) and the second section (20) are slidable with respect to each another. With the slidable feature, the user is then able to adjust the entire length of the mounting frame of the present invention and fix the mounting frame between two adjacent ceiling supports (30).

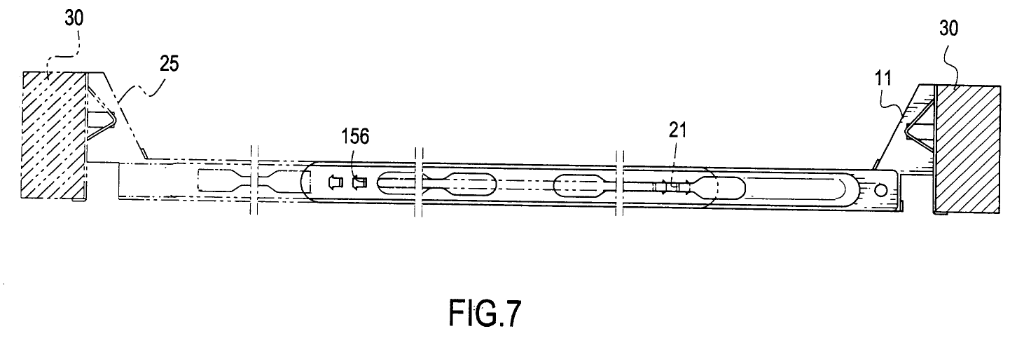

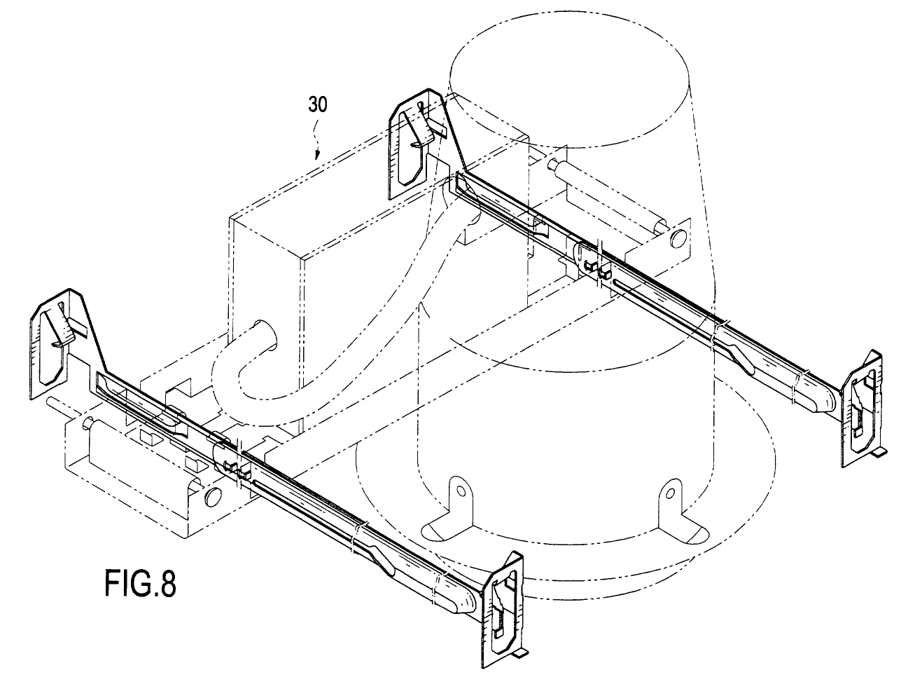

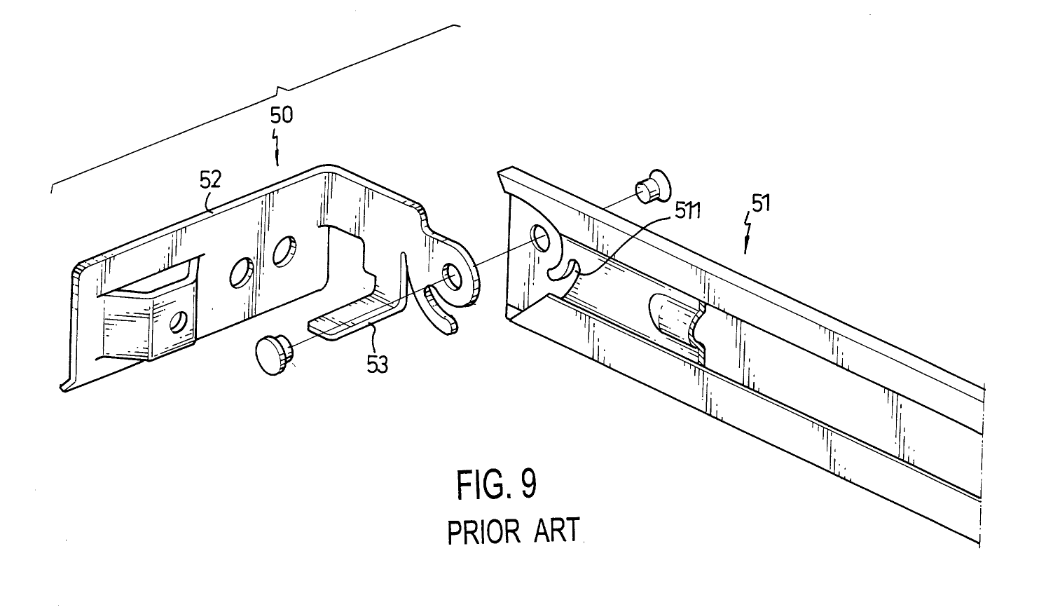

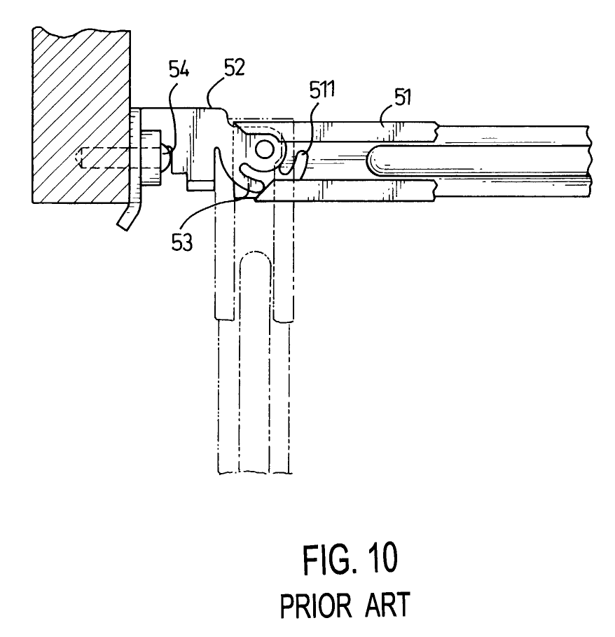

With reference to FIG. 7, it is noted that to support a recessed light (30), two mounting frames are required to be horizontally employed on opposite sides of the recessed light (30) so that the recessed light (30) is able to be supported by the two mounting frames.

It can be concluded that the mounting frame of the present invention has advantages such as:

With the different magnitudes of deformation, the structural integrity is this reinforced.

The stop (116) allows the user to initially position the first head (11) so that the user is able to readily fix the first section (10) on the ceiling support (30).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a mounting frame for a recessed light, the mounting frame having a first section with a first head and a first body pivotally connected to the first head and a second section with a second body and a second head securely and firmly connected to the second body, wherein the improvements comprise:
the first head has a positioning device formed on a side face of the first head to allow the first section to be initially positioned on a surface, a first deformation with a first magnitude formed on the first body, a second deformation with a second magnitude formed on the first body and a guiding path longitudinally defined in the first body.

2. The mounting frame as claimed in claim 1, wherein the positioning device is a stop.

3. The mounting frame as claimed in claim 1, wherein the second body has a third deformation with a third magnitude formed on the second body, a fourth deformation with a fourth magnitude formed on the second body and a third guiding path longitudinally defined in the third deformation.

4. The mounting frame as claimed in claim 3, wherein the second body further has a fourth path longitudinally defined in the fourth deformation.

5. The mounting frame as claimed in claim 2, wherein the second body has a third deformation with a third magnitude formed on the second body, a fourth deformation with a fourth magnitude formed on the second body and a third guiding path longitudinally defined in the third deformation.

6. The mounting frame as claimed in claim 5, wherein the second body further has a fourth path longitudinally defined in the fourth deformation.
